(19) United States
(12) Patent Application Publication
(10) Pub. No.: US 2022/0022288 A1
(43) Pub. Date: Jan. 20, 2022

(54) GLASS-CERAMIC ARTICLE

(71) Applicant: EUROKERA S.N.C., CHATEAU THIERRY (FR)

(72) Inventors: Thibault GUEDON, PARIS (FR); Michaël RAVEL, BARZY SUR MARNE (FR); Grégory DEBREYER, MONTCOURT FROMONVILLE (FR)

(21) Appl. No.: 17/297,840

(22) PCT Filed: Nov. 28, 2019
(86) PCT No.: PCT/FR2019/052828

§ 371 Date: May 27, 2021

(30) Foreign Application Priority Data
Nov. 30, 2018 (FR) 1872169

(51) Int. Cl. H05B 3/74; F16B 1/00; H05B 6/12; F24C 7/06; F24C 15/10; A47B 77/08; A47B 77/02

(52) U.S. Cl. CPC H05B 3/74; F16B 1/00; H05B 6/1209; F16B 2001/0035; F24C 15/108; A47B 77/08; A47B 77/022; F24C 7/067

(57) ABSTRACT

An item, in particular for domestic and/or furniture use, in particular a countertop or furniture unit, includes a carcass on which a glass-ceramic assembly is arranged, the glass-ceramic assembly including a glass-ceramic plate and an electronic module including at least one heating element, the carcass including a support surface on which the glass-ceramic plate is placed and fastened and a housing in which the heating element is arranged, wherein the glass-ceramic plate bears a fastening system for reversibly fastening it to the carcass.

The present invention relates to the field of items formed from a glass-ceramic plate.

### PRIOR ART

Items formed from a glass-ceramic plate exist, this plate being intended to serve in particular as a countertop or a (in particular horizontal) surface of a furniture unit, this plate having in particular large dimensions (the item being for example the piece of furniture thus formed), the item also comprising elements that are useful for the operation thereof or for the operation of the plate, for example heating elements, electronic components, etc.

Glass ceramic has in particular been used for many years to form glass-ceramic hotplates, which have been highly successful with household appliance retailers, household appliance manufacturers and users on account of their attractive appearance and ease of cleaning.

For their part, countertops are generally made of other materials, for example wood, quartz, Corian®, etc. However, the use of glass-ceramic plates to produce these countertops, although bringing about problems that are specific to this material, has proven to be particularly attractive.

A glass ceramic starts out as a glass, referred to as precursor glass (or mother glass or green glass), the specific chemical composition of which allows controlled crystallization to be brought about through suitable heat treatments referred to as ceramification. This partially crystallized specific structure gives the glass ceramic unique properties.

Each glass-ceramic product is the result of specific research and numerous tests, given that it is very tricky to make modifications to glass ceramics and/or to the method for obtaining them without risking an unfavorable effect on the desired properties: for example, when used conventionally as a hotplate, a glass-ceramic plate of black appearance generally has to exhibit transmission in the visible range that is both sufficiently low to conceal the underlying heating elements at rest and sufficiently high for the user to be able to visually detect said elements when they are in operation for safety reasons and/or to be able to read any displays. Glass-ceramic plates also have to have sufficient mechanical strength as required for the use thereof, in particular and all the more so when they have a large size, in particular, in the field of household appliances, and have to have good resistance (defined for example according to the standard EN 60335-2-6 when they are used conventionally as hotplates) to pressure, to impacts (supporting and withstanding the dropping of utensils, etc.), etc.

In order to fulfill the function(s) assigned to it, the glass-ceramic plate is generally provided with accessories or additional (decorative or functional) elements required for the final use thereof (for example heating elements or a control panel for hotplates), in particular electronic components, said elements or accessories being generally fastened to the plate permanently, by being set into a housing provided in the plate for that purpose, and/or possibly by being adhesively bonded in a separate area from that of any heating areas that are present. The position and choice of the accessories are thus set in advance, and once the plate and its accessories have been assembled, if an element is defective, the assembly has to be disassembled using specific tools, or the repair involves exchanging the entire plate or assembly.

The disassembly operation is all the more complicated because the glass-ceramic plates are heavy, in particular large plates, and are generally fastened to their support, with a seal in between if need be for safety and sealing matters. Consequently, the use of the glass ceramic combined with electronic components to produce countertops or surfaces of furniture units that are interactive and/or multifunctional causes problems in terms of the fitting or removal of the components, in particular when installations having a modifiable nature are to be produced, any intervention being particularly complex and possibly involving exchanging the assembly in the case of a defective element.

### SUMMARY OF THE INVENTION

Therefore, the present invention seeks to address these drawbacks by providing an item of which the maintenance is simpler and easy to carry out.

To this end, the invention relates to an item, in particular for domestic and/or furniture use, in particular a countertop or furniture unit, comprising a carcass on which a glass-ceramic assembly is arranged, said glass-ceramic assembly comprising a glass-ceramic plate and an electronic module comprising at least one heating element, said carcass comprising a support surface on which the glass-ceramic plate is placed and fastened and a housing in which said heating element is arranged, characterized in that said glass-ceramic plate bears fastening means for reversibly fastening it to said carcass.

This item advantageously allows simpler maintenance since all that is necessary is to act on the reversible fastening means to disconnect the plate from the carcass and to have access to the electronic module in the event of the latter having a fault. Once the fault has been repaired, the plate can be fastened easily to the carcass again.

According to one example, the fastening means comprise at least two assemblies formed of a threaded rod fastened to the glass-ceramic plate and a nut that is able to be screwed onto the threaded rod, said carcass comprising at least one opening into which the threaded rod is inserted.

According to one example, the at least two assemblies are arranged on the axis of symmetry of the larger of the two dimensions of the glass-ceramic plate.

According to one example, the at least two assemblies are arranged on the axis of symmetry of the larger of the two dimensions of the glass-ceramic plate.

According to one example, the fastening means comprise at least four assemblies formed of a threaded rod and a nut that are arranged symmetrically in pairs with respect to the axes of symmetry of the two dimensions of the glass-ceramic plate.

According to one example, the fastening means comprise at least one pair of magnets comprising a magnet fastened to the glass-ceramic plate and a magnet fastened to the carcass, the magnets being arranged so as to be next to one another when the glass-ceramic plate 4 is fastened to the carcass.

According to one example, the fastening means comprise at least two pairs of magnets arranged symmetrically with respect to the axis of symmetry of one of the two dimensions of the glass-ceramic plate.

According to one example, the magnets are in the form of a rectilinear strip.

According to one example, the magnets are in the form of a right-angled structure.

According to one example, the carcass comprises grooves, in each of which one magnet of a pair is arranged.

According to one example, the grooves are dimensioned to have a depth such that the two magnets of a single pair can fit therein.

According to one example, the depth of the grooves is such that the two magnets of a single pair, of the carcass and of the glass-ceramic plate, respectively, are in contact when the plate is fastened to said carcass.

According to one example, said heating element is arranged and fastened in a housing of the carcass and is independent of the glass-ceramic plate.

The present invention also relates to a method for fastening a glass-ceramic plate to a carcass, characterized in that it comprises the following steps of:
providing the glass-ceramic plate and the carcass;
defining the location of at least one threaded rod on a support surface of the carcass and drilling a through-hole at said location;
placing said glass-ceramic plate on said support surface;
coating said threaded rod with adhesive and inserting it into an opening in the glass-ceramic plate in order to fasten it to said glass-ceramic plate;
engaging a nut with the threaded rod in order to keep said glass-ceramic plate on the carcass.

According to one example, the method also comprises, between the step of placing said glass-ceramic plate on said support surface and the step of coating the threaded rod with adhesive, a step in which a block is fastened to said glass-ceramic plate by adhesive bonding, said threaded rod being adhesively bonded to said block.

### DESCRIPTION OF THE FIGURES

Further particular features and advantages will become more clearly apparent from the description given below by way of entirely nonlimiting example, with reference to the appended drawings, in which:

FIGS. 1 to 3 are schematic depictions of the item according to the invention;

FIGS. 4 and 5 are schematic depictions of a first embodiment of the item according to the invention;

FIGS. 6a and 6b and 10 are schematic depictions of the arrangement of the reversible fastening means of the first embodiment of the item according to the invention;

FIGS. 7, 9a and 9b are schematic depictions of a second embodiment of the item according to the invention and associated variants;

FIGS. 8a to 8e are schematic depictions of the arrangement of the reversible fastening means of the first embodiment of the item according to the invention.

### DETAILED DESCRIPTION OF THE INVENTION

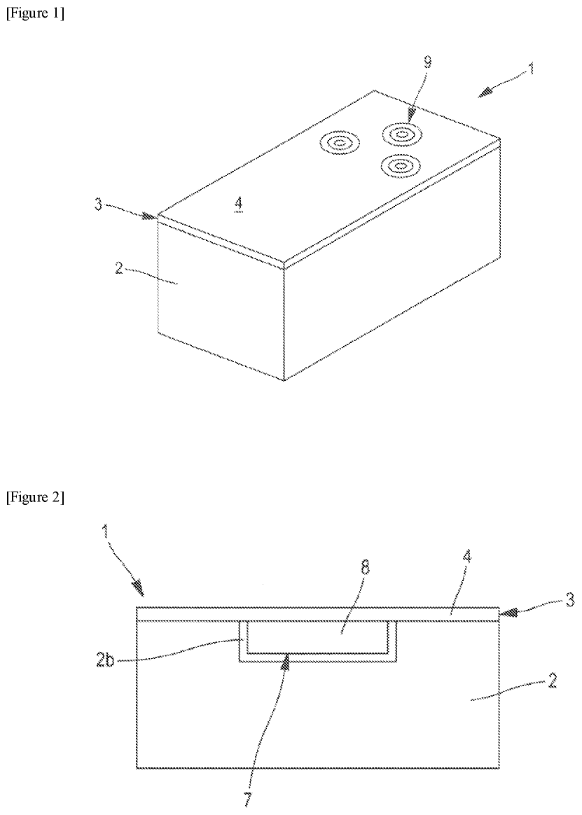

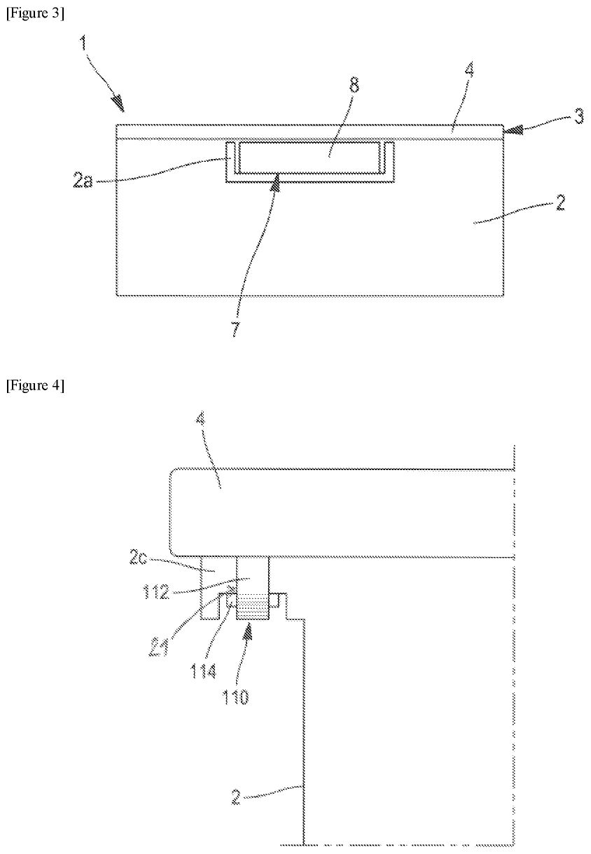

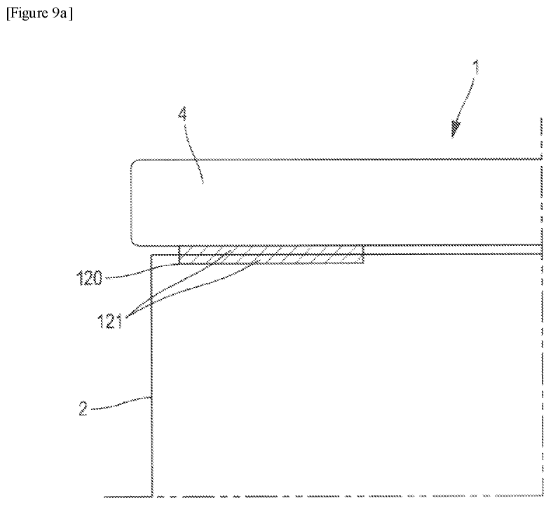

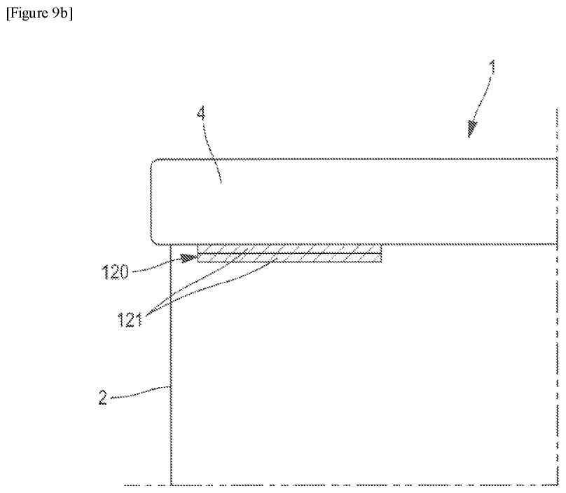

In FIGS. 1 to 3, the item according to the invention is a furniture unit 1, for example a kitchen island, intended for various (successive or simultaneous) uses, including the preparation and consumption of dishes, the support of objects, the cooking of food, etc. This furniture unit is formed of a carcass 2 on which a glass-ceramic assembly is arranged. This carcass 2 or furniture unit comprises a support surface 20 on which the glass-ceramic assembly is placed (visible in FIG. 9a). This glass-ceramic assembly forms a countertop 3 formed entirely (that is to say over its entire area) of a monolithic substrate 4 made of glass ceramic. This substrate has a smooth upper face and a lower face provided with spikes, and has a thickness of 6 mm. The substrate or glass-ceramic plate has a black or white color or any other possible color.

This glass-ceramic assembly also comprises an electronic module 7, which comprises elements for the operation, if need be, of the plate, these elements in particular being, in the present case, heating elements 8 for cooking food, for example inductors, disposed under the plate 4. The location of the heating elements 8 may, if need be, be indicated by decorations 9, made for example of enamel, on the surface of the plate, delimiting the heating areas as required (in FIG. 1, three heating areas are thus shown).

Optionally, the electronic module 7 may also have control means or electrical induction charging means.

In a first embodiment, the electronic module 7 is arranged in the carcass 2, that is to say in the furniture unit supporting said glass-ceramic plate 4. For this purpose, the carcass 2 comprises a housing 2a in which the elements 8 for the operation of the plate are placed. The electronic module 7 is fastened to said carcass 2 by adhesive bonding or screwing or clip fastening.

This arrangement has the advantage of not adding mass to the glass-ceramic plate 4, limiting the tensioning of its lower face while making it easier to handle. This advantage is all the more significant because large glass-ceramic plates having dimensions of 240 cm*110 cm or 360 cm*130 cm exist, these thus having a significant mass. A glass-ceramic substrate having an area of less than or equal to 0.3 m² is considered to be a substrate of standard size, while a glass-ceramic substrate having an area of greater than or equal to 0.7 m² is considered to be a substrate of large size.

In a second embodiment, the electronic module 7 is fastened to said glass-ceramic plate 4 by adhesive bonding or screwing or clip fastening. The carcass 2 thus comprises a housing 2b into which the electronic module 7 is inserted. The housing 2b is realized such that the elements 8 for the operation of the plate fit therein. A relatively large or small gap is provided between the electronic module 7 and the plate 4.

Cleverly according to the invention, the glass-ceramic plate 4 is fastened to the carcass via fastening means 100, the fastening being reversible, the plate 4 bearing fastening means for fastening it reversibly to the carcass 2. This is understood as meaning that the reversible fastening means 100 are such that they can be manipulated in order, firstly, to fasten the glass-ceramic plate 4 to the carcass 2 and, secondly, to separate the glass-ceramic plate 4 from the carcass 2. This separation by manipulating the reversible fastening means 100 takes place without destroying said reversible fastening means 100. In this way, it is possible to manipulate said reversible fastening means 100 again in order to fasten the plate 4 to the carcass again.

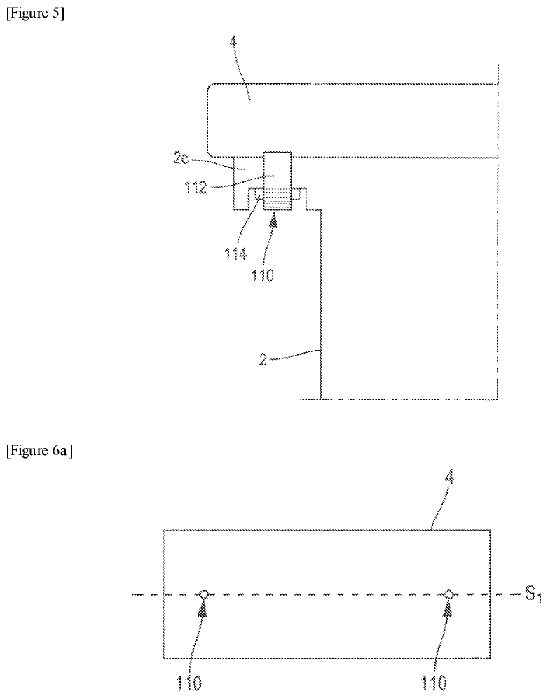

According to a first embodiment, which can be seen in FIGS. 4 and 5, the reversible fastening means 100 comprise an assembly 110 comprising at least one threaded rod 112 of circular section, on which a nut 114 is fastened. The threaded rod 112 is itself borne by the glass-ceramic plate 4 so as to extend orthogonally to the plane of said glass-ceramic plate 4. This fastening of the rod 112 to the glass-ceramic plate 4 can be effected by adhesive bonding.

The adhesive used is an adhesive of the silicone or epoxy type.

It will thus be understood that the reversible fastening means 100 are directly fastened to the glass-ceramic plate 4.

The carcass 2 on which the glass-ceramic plate 4 is placed comprises through-openings 21. These through-openings 21 are positioned such that each rod 112 adhesively bonded to the glass-ceramic plate 4 and each opening in the carcass 2 face one another, allowing each rod 112 to be inserted into a through-opening 21. The carcass 2 thus comprises areas, for example a rim 2c, in which the through-openings 21 are arranged.

This insertion then makes it possible to use a nut 114, which cooperates with said threaded rod such that a rotary action on the nut 114 causes it to move in translation on the rod 112. This movement in translation of the nut 114 allows the latter to fasten the glass-ceramic plate 4 to said carcass 2.

It will be understood that the through-opening 21 has, in a first example, a constant section and is dimensioned such that the threaded rod is inserted into it. This rod 112 protrudes from the carcass 2 so as to allow the nut 114 to be mounted thereon.

In a second example, the opening 21 comprises a first portion having dimensions substantially similar to those of the rod 112 in order to allow the latter to be inserted into it and a second portion, the dimensions of which allow the nut 114 to be inserted into it. Thus, the rod 112 is provided with a length that allows it to protrude into the second portion of the opening 21 so as to allow it to cooperate with the nut 114. Thus, this second example advantageously makes it possible to hide the rod/nut assembly in the thickness of the carcass 2.

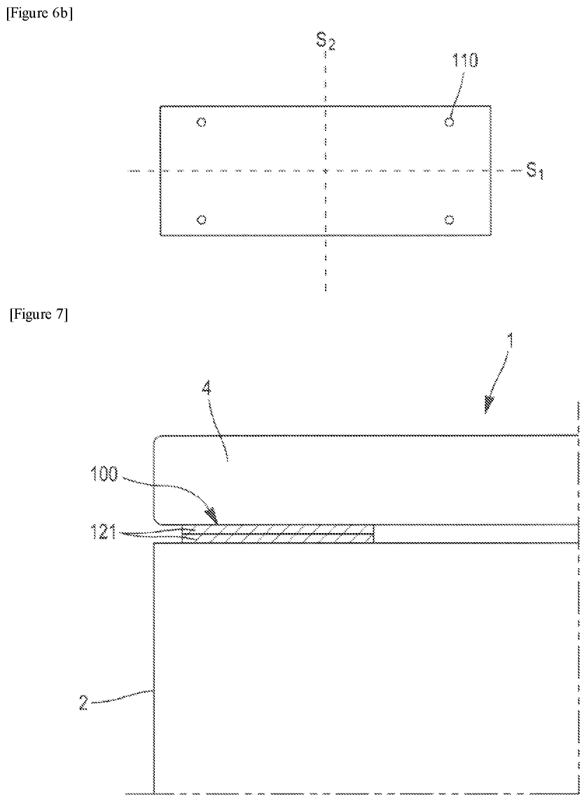

The glass-ceramic plate 4 is fastened to the carcass via at least two threaded rod/nut assemblies 110, as can be seen in FIG. 6a. In this case, the two assemblies 110 are situated on an axis extending in a direction parallel to the larger of the two lengths of the plate. Preferably, these two assemblies 110 will be arranged on the axis of symmetry S1 of the plate 4. Even more preferably, the reversible fastening means 100 comprise four threaded rod/nut assemblies 100, each assembly 110 being situated at a corner of the plate 4, as can be seen in FIG. 6b. These assemblies 110 are thus arranged so as to be symmetric in pairs with respect to the axes of symmetry S1, S2 of the two dimensions of the glass-ceramic plate 4.

In a variant of this first embodiment, the threaded rod 112 is only partially threaded. The thread extends along the rod such that, when the nut 114 arrives at its end of travel, the glass-ceramic plate 4 is fastened and there is no play in the fastening.

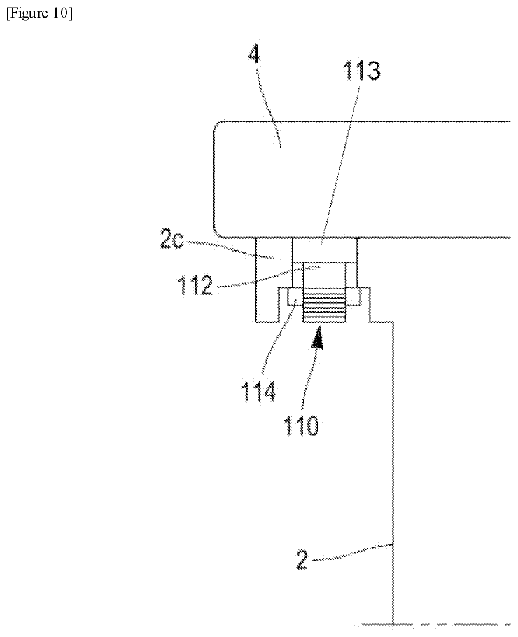

In another variant of this first embodiment, which can be seen in FIG. 10, the threaded rod 112 is mounted on a block 113, itself adhesively bonded to the plate. This block 113, which is part of the fastening means, has a contact area with the substrate that is larger than the contact area of the rod 112. This larger contact area allows better resistance to the stresses that can be applied to the threaded rod 112.

This block 113 is an element to which the threaded rod is attached or is made as one with said rod.

In an alternative of this variant that is not shown, the block 113 is designed such that two threaded rods 112 can extend from said block 113.

This first embodiment and the variants thereof advantageously make it possible to improve the method for mounting said plate. This improved mounting method consists in fastening the threaded rod(s) 112 to the glass-ceramic plate 4 after said glass-ceramic plate 4 has been placed on the furniture unit 2. The method therefore consists, after a step in which said glass-ceramic plate 4 is placed and adjusted on the furniture unit 2, in providing a step of fastening the rod.

This step of fastening the threaded rod 112 consists, firstly, in defining the location of each threaded rod on the support surface 20 of the carcass 2. Secondly, through-holes 21 are drilled at the defined locations. Thirdly, the glass-ceramic plate 4 is placed on the furniture unit and then the rods are fastened to the glass-ceramic plate 4 through the through-holes 21. This fastening is ensured by adhesive that is applied to each rod 112 before said rod is inserted into a through-opening.

In the case of threaded rods alone, these are fastened directly to the glass-ceramic plate 4. When a block 113 is used, if the latter is made as one with the threaded rod, the rod/block assembly is fastened to the glass-ceramic plate. If the block and the rod are independent, the block 113 is fastened to the glass-ceramic plate 4 by adhesive bonding and then the threaded rod 112 is fastened to said block 113. Fourthly, the nuts 114 are joined to the threaded rods.

The through-holes 21 will be dimensioned such that the rods 112 can be inserted into them without friction. Thus, provision could be made for the minimum diameter of the through-holes to be identical, with tolerances, to the diameter of the threaded rods 112. However, it is possible to have through-holes 21 with a much larger diameter than that of the threaded rods. In this case, grommets or pegs can be inserted into said holes 21 in order to receive said threaded rods.

This method advantageously makes it possible to have perfect alignment between the threaded rods 112 and the holes 21 so that there are no problems during mounting and so as to avoid the stresses applied to said rods 112 in the case of an offset. Moreover, this makes it easier to transport the glass-ceramic plate 4 compared with a glass-ceramic plate 4 having rods 112 fastened before placement on the carcass 2. Effectively, the threaded rods 112, once mounted on the glass-ceramic plate 4, protrude. Thus, the glass-ceramic plates 4 have to be manipulated in order to avoid impacts on the rods 112 that would involve the risk of unsticking or deforming them. By fastening the rods 112 once the glass-ceramic plate 4 has been placed on the carcass 2, these inconveniences are avoided. Moreover, this method advantageously makes it possible to position the threaded rods 112 depending on the configuration of the furniture unit, that is to say at the most accessible locations and at locations other than where the electronic module(s) 7 is/are located.

According to a second embodiment, which can be seen in FIG. 7, the reversible fastening means 100 comprise at least one pair of magnets 121. This pair of magnets is arranged so as to have one magnet 121 arranged on the plate 4, in particular on its face in contact with the carcass 2, and one magnet 121 on the carcass 2, in particular on its face in contact with said plate 4. This pair of magnets 121 is arranged such that the magnets 121 attract one another, meaning that the magnet 121 arranged on the plate 4 is attracted by the magnet 121 arranged on the carcass 2. This thus brings about a tractive force between the carcass 2 and the plate 4.

Each magnet 121 is fastened to the carcass 2 or to the glass-ceramic plate 4 by adhesive bonding. The magnet 121 fastened to the carcass can be fastened by screwing. For this purpose, it is provided with a hole that allows a screw to be inserted into it.

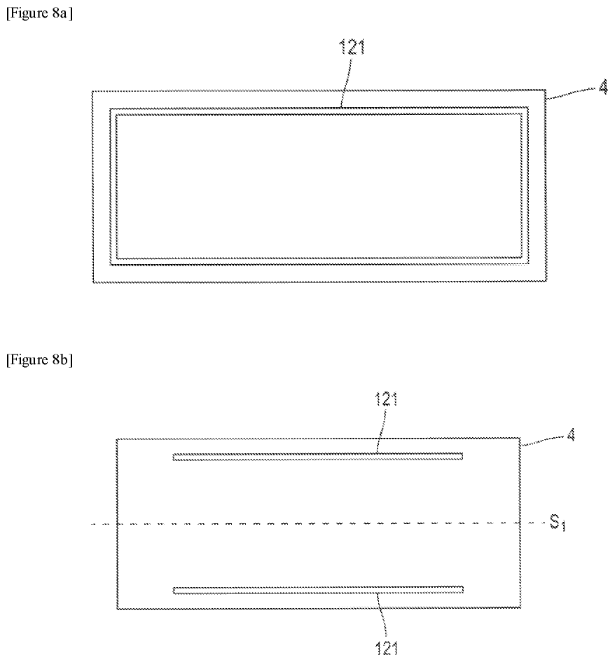

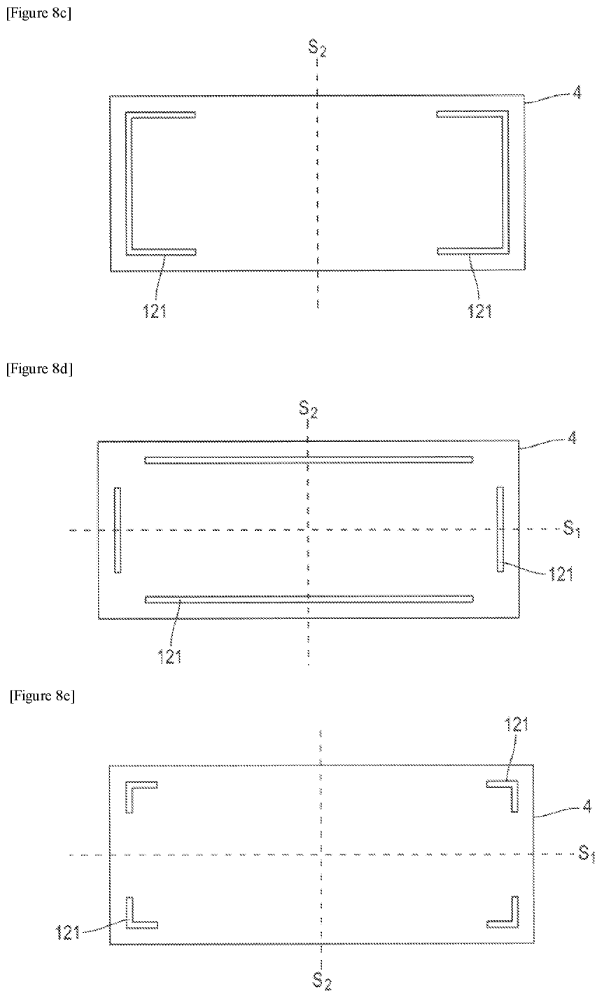

According to a first visible example, the reversible fastening means 100 comprise one pair of magnets 121, each magnet 121 having a strip shape designed to delimit a rectangular perimeter, as can be seen in FIG. 8a, where the magnet 121 of the glass-ceramic plate 4 is depicted.

During the mounting of the plate 4 on the carcass 2, the plate is positioned such that the magnet 121 that it bears comes into contact with the magnet 121 borne by said carcass 2, ensuring that the plate 4 is fastened.

According to a second example, the reversible fastening means 100 comprise two pairs of magnets 121. These magnets 121 can have various shapes, such as a rectilinear strip shape or a strip shape designed to delimit a U, as can be seen in FIGS. 8b and 8c, where the magnets 121 of the glass-ceramic plate 4 are depicted. These magnets 121 are arranged such that the two magnets 121 of the plate 4 are symmetric with respect to the transversal S2 of the larger of the two dimensions of the plate 4 or with respect to or symmetric with respect to an axis S1 parallel to the larger of the dimensions.

According to a third example, which can be seen in FIGS. 8d and 8e, the reversible fastening means 100 comprise four pairs of magnets 121. These magnets 121 can have various shapes, such as a rectilinear strip shape or a right-angled strip shape, that is to say two portions forming a right angle.

These magnets 121 are arranged so as to be symmetrically opposite one another in pairs. In the case of magnets 121 in the form of a right-angled structure, these are advantageously arranged at the corners of the plate 4 and of the carcass.

According to one variant of the invention, which can be seen in FIGS. 9a and 9b, the carcass 2 is designed to comprise grooves 120 or slots in which the magnets 121 fastened to the carcass 2 are positioned. Preferably, these grooves or slots 120 are dimensioned to accommodate the magnets 121 of a single pair. This should be understood as meaning that the grooves or slots 120 have a depth such that, during the positioning of the plate 4 on the carcass, each groove or slot 120 is able to house the two magnets of a single pair. It may be added that the depth is such that, when the plate 4 is fitted on the carcass 2, the magnets of a single pair are in contact and the plate 4 is in contact with the carcass 2.

This variant advantageously makes it possible to improve fastening since, while the magnets 121 allow fastening with respect to traction orthogonal to the plane of the plate, these slots 120 allow a lateral hold. Specifically, since the magnets 121 of the plate are also inserted into the grooves 120 or slots, the sides of these grooves or slots 120 serve as stops. Thus, when a force is applied laterally to said plate 4, the magnets 121 adhesively bonded to the plate 4 butt against the sides of the grooves or slots 20 so as to prevent any offsetting of said plate. Preferably, the dimensions of the grooves or slots 120 are such that the magnets can be inserted into them without, however, being able to move laterally therein.

Of course, the present invention is not limited to the example illustrated but is able to be varied and modified in various ways that will be apparent to a person skilled in the art. Thus, in a third embodiment, the reversible fastening means combines the pairs of magnets and the rod/nut assemblies. For example, there may be four pairs of magnets and one rod/nut assembly for securing the glass-ceramic plate 4 to the carcass 2.

1. An item, comprising a carcass on which a glass-ceramic assembly is arranged, said glass-ceramic assembly comprising a glass-ceramic plate and an electronic module comprising at least one heating element, said carcass comprising a support surface on which the glass-ceramic plate is placed and fastened and a housing in which said at least one heating element is arranged, wherein said glass-ceramic plate directly bears a fastening system to fasten it to said carcass.

2. The item as claimed in claim 1, wherein the fastening system comprises at least two assemblies formed of a threaded rod fastened to the glass-ceramic plate and a nut that is able to be screwed onto the threaded rod, said carcass comprising at least one opening into which the threaded rod is inserted.

3. The item as claimed in claim 2, wherein the threaded rod is mounted on a block adhesively bonded to the glass-ceramic plate.

4. The item as claimed in claim 2, wherein the at least two assemblies are arranged on an axis of symmetry of a larger of the two dimensions of the glass-ceramic plate.

5. The item as claimed in claim 2, wherein the at least two assemblies are arranged on an axis of symmetry of a smaller of the two dimensions of the glass-ceramic plate.

6. The item as claimed in claim 2, wherein the fastening system comprises at least four assemblies formed of a threaded rod and a nut that are arranged symmetrically in pairs with respect to axes of symmetry of the two dimensions of the glass-ceramic plate.

7. The item as claimed in claim 1, wherein the fastening system comprises at least one pair of magnets comprising a magnet fastened to the glass-ceramic plate and a magnet fastened to the carcass, the magnets being arranged so as to be next to one another when the glass-ceramic plate is fastened to the carcass.

8. The item as claimed in claim 7, wherein the fastening system comprises at least two pairs of magnets arranged symmetrically with respect to an axis of symmetry of one of the two dimensions of the glass-ceramic plate.

9. The item as claimed in claim 8, wherein the magnets are in the form of a rectilinear strip.

10. The item as claimed in claim 8, wherein the magnets are in the form of a right-angled structure.

11. The item as claimed in claim 7, wherein the carcass comprises grooves, in each of which one magnet of a pair is arranged.

12. The item as claimed in claim 11, wherein the grooves are dimensioned to have a depth such that the two magnets of a single pair can fit therein.

13. The item as claimed in claim 12, wherein a depth of the grooves is such that the two magnets of a single pair, of the carcass and of the glass-ceramic plate, respectively, are in contact when the glass-ceramic plate is fastened to said carcass.

14. The item as claimed in claim 1, wherein said at least one heating element is arranged and fastened in a housing of the carcass and is independent of the glass-ceramic plate.

15. A method for fastening a glass-ceramic plate to a carcass for an item as claimed in claim 1, comprising:
providing the glass-ceramic plate and the carcass;
defining a location of at least one threaded rod on a support surface of the carcass and drilling a through-hole at said location;
placing said glass-ceramic plate on said support surface;
coating said threaded rod with adhesive and inserting it into an opening in the glass-ceramic plate in order to fasten it to said glass-ceramic plate;
engaging a nut with the threaded rod in order to reversibly fasten said glass-ceramic plate to the carcass.

16. The method for fastening a glass-ceramic plate as claimed in claim 15, further comprising, between the placing of said glass-ceramic plate on said support surface and the coating of the threaded rod with adhesive, fastening a block to said glass-ceramic plate by adhesive bonding, said threaded rod being adhesively bonded to said block.

17. The item as claimed in claim 1, wherein the item is a countertop or furniture unit.
